(19) United States
(12) Patent Application Publication
(10) Pub. No.: US 2019/0244237 A1
(43) Pub. Date: Aug. 8, 2019

(54) INTERMEDIARY TO MANAGE A POINT EXCHANGE ACROSS A PLURALITY OF DIFFERENT REWARD PROGRAMS

(71) Applicant: Comenity LLC, Columbus, OH (US)

(72) Inventors: James MAGNUSON, JR., Columbus, OH (US); Tom PUGH, Powell, OH (US); Chris KACMARSKY, Columbus, OH (US); Uchenna CHILAKA, Gahanna, OH (US); Christian BILLMAN, Gahanna, OH (US)

(73) Assignee: Comenity LLC, Columbus, OH (US)

(21) Appl. No.: 16/042,142

(22) Filed: Jul. 23, 2018

Related U.S. Application Data
(60) Provisional application No. 62/625,603, filed on Feb. 2, 2018.

(51) Int. Cl. G06Q 30/02

(52) U.S. Cl. CPC G06Q 30/0227; G06Q 30/0233

(57) ABSTRACT

Systems and methods for an intermediary to manage a point exchange across a plurality of different reward programs and across a plurality of users (e.g., disparate retailers as well as disparate consumers) are disclosed. One method receives a plurality of first reward program points from an entity; each point having a monetary value for the date it was issued. A total monetary value of the plurality of first reward program points is determined. The total monetary value is exchanged into an equivalent value of an intermediary currency. The entity requests one or more second reward program points. A current value of each second reward program point is obtained and the equivalent value in the intermediary currency is determined. An amount of intermediary currency is exchanged for the one or more second reward program points. The one or more second reward program points are provided to the entity.

### CROSS-REFERENCE TO RELATED APPLICATIONS (PROVISIONAL)

This application claims priority to and benefit of co-pending U.S. Provisional Patent Application No. 62/625,603 filed on Feb. 2, 2018, entitled “AN INTERMEDIARY TO MANAGE A POINT EXCHANGE ACROSS A PLURALITY OF DIFFERENT REWARD PROGRAMS” by James Magnuson, Jr. et al., and assigned to the assignee of the present application, the disclosure of which is hereby incorporated herein by reference in its entirety.

### BACKGROUND

Company specific, brand specific and even store specific reward point programs provide significant value to both consumer and provider. By issuing reward points, the provider is able to maintain consumer brand loyalty. Similarly, the consumer receives the perks from utilizing the reward points. However, unclaimed reward points will deleteriously remain as outstanding liability on the reward point provider's books.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a computing device communicating via the cloud to a plurality of different reward programs, in accordance with an embodiment.

FIG. 2 is a block diagram of an intermediary system to manage a point exchange across a plurality of different reward programs, in accordance with an embodiment.

FIG. 3 is a block diagram of further detailed version of an intermediary system to manage a point exchange across a plurality of different reward programs, in accordance with an embodiment.

FIG. 4 is a flowchart of a method for utilizing an intermediary to manage a point exchange across a plurality of different reward programs, in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting”, “deploying” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

It should be appreciated that the obtaining or accessing of user information conforms to applicable privacy laws (e.g., federal privacy laws, state privacy laws, etc.) and applicable fair credit reporting act laws. In one embodiment, prior to accessing user information, the user affirmatively “opts-in” to the services described herein. For example, during the use of an issuer's mobile application, the user is prompted with a choice to affirmatively “opt-in” to various services. As a result, any information is obtained with the user's prior permission. Moreover, depending on present or future credit account requirements, rules and regulations, the credit application aspects described herein may be more or less formal.

### Overview

For purposes of the following discussion, the term reward points program refers to a marketing strategy program used by a merchant that utilizes reward points as a means for attracting new customers, rewarding existing customers, rewarding customer purchases, and the like. Basically, the reward point program provides a varying number of points for different acts such as: signing up, making a purchase, an anniversary of one or more dates, etc. In general, after performing one or more of the acts, the reward points program will provide a given number of reward points to the customer. Because of the different types of rewards points provided, the actual monetary value of each reward point can be different across merchants and even across different reward point programs for the same merchant.

For example, a coffee shop could provide reward points such that after 9 coffee purchases, the 10^{th} coffee is free. In this case, the reward point would have a value of 119^{th} of the price of a cup of coffee. In a multi-tiered point program, such as a credit card reward points program, there could be a varying number of points that are earned depending on what is being purchased. For example, a first number of points (e.g., 1) are earned for each hundred dollars spent on any purchases, a different number of points (e.g., 2) are earned for each hundred dollars spent on grocery purchases, yet a different number of points (e.g., 5) are earned for each hundred dollars spent on airline travel purchases, etc. In one embodiment, each point of the multi-tiered points program would be the same value regardless of how it was earned. In another example, a merchant may have a number of different reward point programs, and the points in each of the different programs could have the same or varying values depending upon the program.

In general, the exchange provides an entity (e.g., a user, customer, reward point holder, etc.) with access to a wider network of participating point programs and the capability for the entity to exchange points received from one retailer program to points for another retailer program. The exchange will include retailers and rewards program management companies (i.e. credit card companies, multi-tender loyalty companies, etc.) in the network that can authenticate transactions shared and provide input into the consensus model for the exchange program. Once points are exchanged, the exchange will provide an update to each of the rewards program management companies to update the balances for each affected account. Additionally, in one embodiment the exchange will deduct a certain amount of points from the total for each exchange, providing a steady state of “point's burn” to prevent unlimited liability. In one embodiment, the exchange would charge a nominal fee for the exchange. In one embodiment, the fee would be shared with the retailers and/or rewards program management companies to offset liability created by the additional rewards fulfillments.

In one embodiment, the exchange will transfer points from a reward program into an equivalent value of exchange currency, like a “point-coin” with its own value, expiration date, unique identifier, embedded business rules, and the like. In one embodiment, the exchange will use digital ledger technology. In one embodiment, the exchange is a mobile application that will reside on the entity's computing system (e.g., desktop, laptop, mobile device, etc.), maintain the entities' identity and confirmed reward points balances for one or more reward programs.

Using the exchange provides a capability to determine and exchange value between two or more retailer rewards programs with disparate point value assignments. The exchange further allows multiple retailers to participate in the points exchange program without requiring the retailers to set up relationships with each other. In one embodiment, the exchange utilizes a digital ledger methodology to on-board participating parties (e.g., credit card companies, multi-tender loyalty companies, etc.), identify points, verify user identity, exchange value across the users and confirm in the ledger for future reconciliation of the exchange. The exchange will track and monitor multiple rewards programs and acceptable exchange rates between these programs. In one embodiment, the exchange utilizes its own monetary system such that business rules for managing the points are embedded in the points themselves or in the exchange's own monetary system, and not in the overall program used to manage the points.

Importantly, the embodiments of the present invention, as will be described below, provide a process for exchanging reward points from disparate reward programs which differs significantly from the conventional processes. In conventional approaches, exchanging points between programs is difficult, requires the different programs to work together, which is not likely in a competitive scenario. Such conventional approaches are not possible without significant support, and are tedious, time-consuming, and can oftentimes be flat-out denied as a point exchange opportunity. Such conventional approaches also require agreement on the value of the points to facilitate sharing points across participating retailers, which is difficult even amongst non-competitors and impractical when extended beyond just one or two participating retailers. However, the present embodiments, as will be described and explained below in detail, provide a previously unknown procedure to allow multiple retailers to participate in a points exchange program without requiring the retailers to set up relationships with each other. Thus, embodiments of the present invention provide a streamlined method for point exchange that includes tracking and monitoring multiple rewards programs and acceptable exchange rates between these programs. Provide authentication of the points being exchanged prior to allowing the exchange to occur, and in one embodiment, the exchange will utilizes its own monetary system as the center of the exchange to provide a real-time point value exchange capability that extends well beyond what was previously possible.

As will be described in detail, the various embodiments of the present invention do not merely implement conventional processes for utilizing an intermediary (or central exchange) to manage a point exchange across a plurality of different reward programs on a computer. Instead, the various embodiments of the present invention, in part, provide a previously unknown procedure for providing a method for point exchange that includes tracking and monitoring multiple rewards programs and acceptable exchange rates between these programs, providing authentication of the points being exchanged prior to allowing the exchange to occur, and utilizing an exchange specific currency for its own monetary system as the center of the exchange process to provide a real-time point value exchange capability. Hence, embodiments of the present invention provide a novel process for reward program to reward program point exchange which is necessarily rooted in computer technology to overcome a problem specifically arising in the realm of reward point exchange.

Moreover, the embodiments do not recite a mathematical algorithm; nor do they recite a fundamental economic or longstanding commercial practice. Instead, they address a number of business challenges including providing a means of determining and exchanging value between multiple retailer rewards programs with disparate point value assignment. Another benefit is the capability to allow multiple retailers to participate in a points exchange program without setting up relationships between the multiple retailers. Thus, the embodiments do not merely recite the performance of some business practice known from the pre-Internet world along with the requirement to perform it on the Internet. Instead, the embodiments are necessarily rooted in computer technology in order to overcome problems specifically arising in the realm of reward point utilization.

### Operation

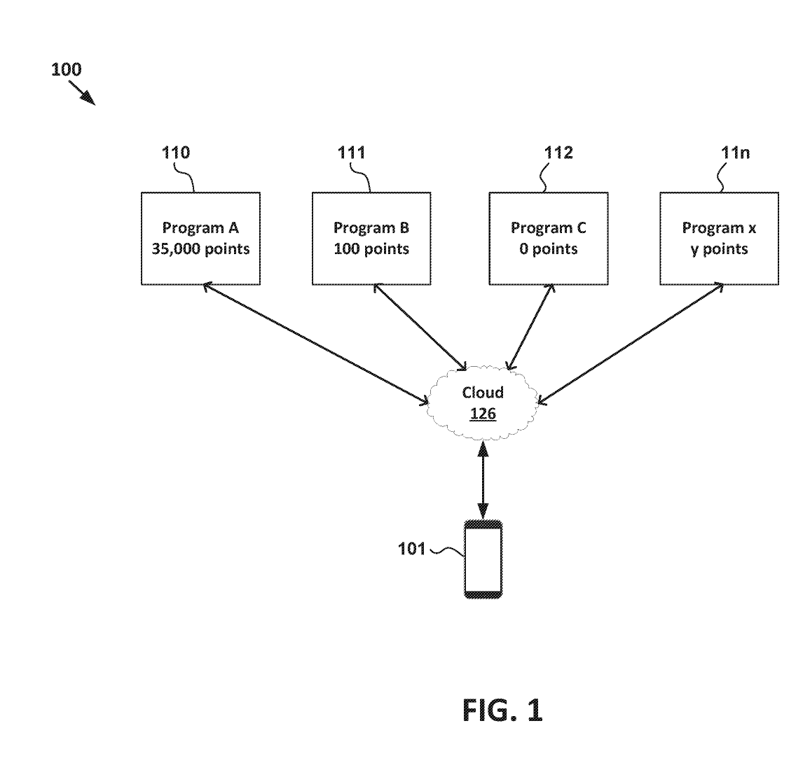

With reference now to FIG. 1, a block diagram 100 of a computing device 101 communicating via the cloud 126 to a plurality of different reward programs 110-11n is shown in accordance with an embodiment. Although a number of distinct reward programs 110-11n are shown in block diagram 100, it should be appreciated that one or more of the programs 110-11n could be found in a similar storage location, operating on computing device 101, on applications stored on computing device 101, or the like.

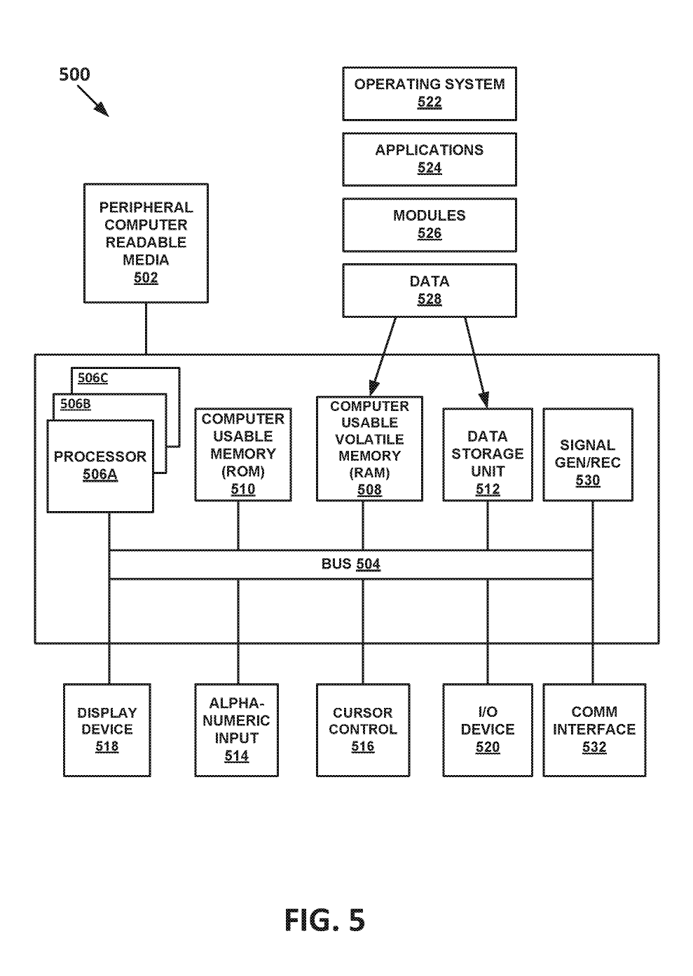

Computing device 101 may be a laptop, a desktop, a point of sale terminal, a mobile phone, a smart phone, a tablet, a smart watch, a piece of smart jewelry, smart glasses, or other electronic devices having wireless connectivity. Such that computing device 101 would be capable of broadcasting and receiving via at least one network cloud 126. Computing device 101 can include one or more of the components described in detail in the description of FIG. 5.

Cloud 126 represents a wired or wireless network such as the Internet, a wide area network (WAN), local area network (LAN), or the like. A wired network can include Ethernet cable(s), phone line(s), router(s), switch(es), and the like. Wireless communication network examples include: WiFi, Cellular, Bluetooth, NFC, and the like.

In the diagram, each of the plurality of different reward programs 110-11n includes a different number of reward points for purposes of clarity in the following discussion. However, it should be appreciated that there may be more of fewer points in one or more of the different reward programs 110-11n than shown. Further, the entity can be associated with more or fewer than the reward programs 110-11n shown.

Although the reward programs 110-11n are shown as being a network connection away from computing device 101, it should be appreciated that one or more of the programs 110-11n could be operating on computing device 101, such as applications on computing device 101, or the like. The distinct separation of programs 110-11n and computing device 101 is provided for purposes of clarity.

In one embodiment, the entity is a customer that is a member of at least two of the different reward programs 110-11n. For example, the customer is a member of program A 110 and has 35,000 points and the customer would like to exchange some or all of programs A 110 points to obtain points for program x 11n, of which the customer is also a member.

In another embodiment, the entity is a customer that is a member of one or more of the different reward programs 110-11n, and would be using the point exchange to obtain program points for which the entity is not a member. For example, the customer is a member of program A 110 and has 35,000 points. However, the customer would like to exchange some or all of those program A 110 points to obtain points for program C 112, of which the customer is not a member.

In one embodiment, the entity is a customer that is a member of at least two of the different reward programs 110-11n. For example, the customer is a member of program A 110 and has 35,000 points and program B 111 and has 100 points. In one embodiment, the customer would like to exchange some or all of programs A 110 points and some or all of program B 111 points to obtain points for program x 11n, of which the customer is or is not a member.

In one embodiment, the exchange can also facilitate peer-to-peer exchange. The peer-to-peer exchange can be between two or more entities across any number of reward programs 110-11n. For example, one entity is Customer X that is a member of one of the reward programs 110-11n and would like to exchange rewards points with a different Customer Y of the same or different rewards program 110-11n. For example, Customer X in program A 110 can exchange rewards points with Customer Y in program B 111 at a value that is appropriate within the rules of each rewards program.

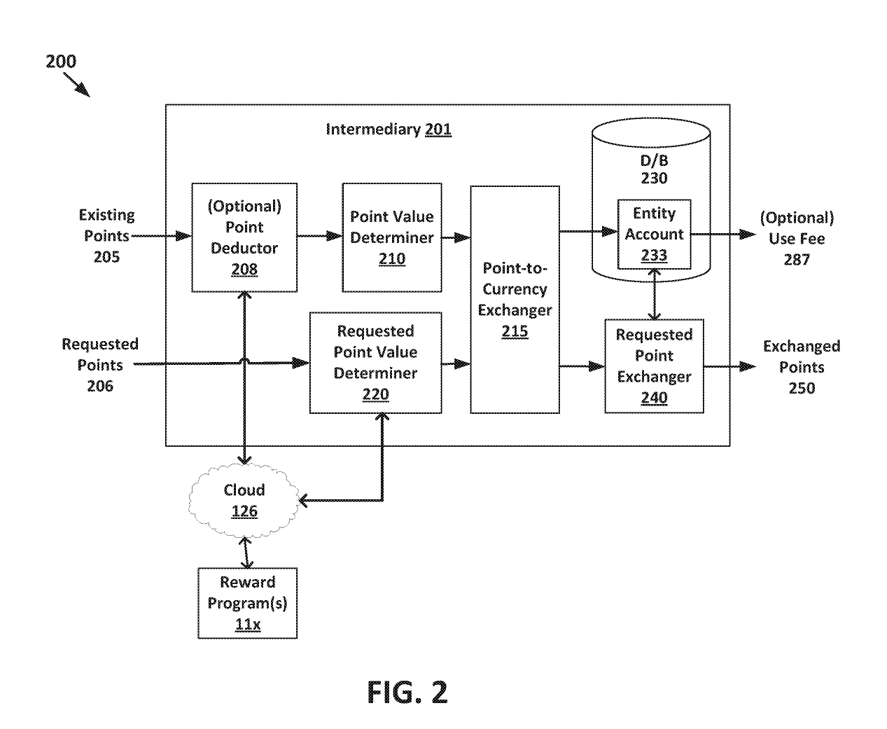

Referring now to FIG. 2, a block diagram 200 of an intermediary system 201 (e.g., a central exchange) to manage a point exchange across a plurality of different reward programs is shown in accordance with an embodiment. Although a number of distinct components are shown in block diagram 200, it should be appreciated that one or more of the components of intermediary system 201 may be combined. Similarly, one or more of the components of intermediary system 201 could be located separately from one another and communicate via cloud 126 or the like.

In one embodiment, intermediary system 201 is an application operating on the entity's computing device 101. In another embodiment, intermediary system 201 operates on a server that includes memory, processors, applications, operating systems and the like (such as described in FIG. 5). If intermediary system 201 operates on a remote server is could communicate with computing device 101 on a secure channel via cloud 126. In one embodiment, intermediary system 201 is responsible for data provided by an application operating on computing device 101 and can include the entity database 230 that stores account details for the entity account 233.

In general, intermediary system 201 receives existing points 205 which are reward program points that have already been awarded to an entity. Intermediary system 201 also receives a requested points 206 input. Requested points 206 are the points which the entity would like to obtain in exchange for some or all of the existing points 205. Intermediary system 201 will provide some number of the exchanged points 250.

In one embodiment, if there is a use fee 287, the use fee 287 is also provided by intermediary system 201. The use fee 287 could be provided to rewards program management companies to offset liability created by the additional rewards fulfillments, to retailers, to a provider or maintainer of intermediary system 201, another party, or a combination of two or more of the different parties.

Intermediary system 201 includes an optional point deductor 208, point value determiner 210, point-to-currency exchanger 215, requested point value determiner 220, database 230, and requested point exchanger 240.

Optional point deductor 208 receives the existing points 205 and then deducts some portion thereof. For example, optional point deductor 208 will deduct a certain amount of points from the total for each exchange, thereby providing a steady state of “points burn” to prevent unlimited liability. In one embodiment, optional point deductor 208 will utilize a network connection such as cloud 126 to access the reward program(s) 11x and inform the point program of the points burn.

In one embodiment, point deductor 208 includes a point life expectancy feature. For example, in one embodiment the point life expectancy feature is an on/off configuration for the exchange network on the whole. If on, existing points 205 (or their equivalent intermediary currency, or the exchanged points 250) would have a date at which they will lose value or disappear from the entity account 233. Likewise, existing points 205 (or their equivalent intermediary currency, or the exchanged points 250) could decrease in value over time.

In one embodiment, the life expectancy feature could be reset when transferred from one brand to the other either because the particular token has an expiration reset or more informally because the points leave the network (e.g., intermediary 201) and then rejoin at a later date. If the life expectancy feature is off, the network functions exactly as-is with no additional loss in value of existing points 205 (or their equivalent intermediary currency, or the exchanged points 250). By utilizing the on/off life expectancy feature, point deductor 208, will enable some breakage if at a later date it is determined breakage needs to be introduced. In one embodiment, points already in the network prior to the life expectancy feature being turned on would maintain their “immortal” status while any new points would have a mortality rate with dates.

Point value determiner 210 will determine the monetary value of each point from the received existing points 205. For example, point value determiner 210 will access the point reward information for each point provided. Examples of data (or a plurality of metrics) associated with each first reward program point includes data, such as but not limited to, a date the first reward program point was issued, a time the first reward program point was issued, a physical location of computing device 101 when the first reward program point was issued, a monetary value of the first reward program point on a date the first reward program point was issued by a first reward program, information identifying the first reward program, information identifying the entity that owns of the first reward program point, information identifying a date the first reward program point was obtained by the entity, and the like. In so doing, point value determiner 210 will be able to determine the actual monetary value of each point of existing points 205 and therefore the total monetary value for existing points 205.

Requested point value determiner 220 operates similar to point value determiner 210 except that requested point value determiner 220 will determine the present value for each point of the requested points 206. In one embodiment, requested point value determiner 220 will utilize a network connection such as cloud 126 to access the reward program(s) 11x to obtain the present value of the requested points 206.

Point-to-currency exchanger 215 will receive the determined monetary value of the existing points 205 from point value determiner 210 and then change that value into an intermediary currency (or central exchange currency) value. Similarly, point-to-currency exchanger 215 will receive the present value for each point of the requested points 206 from requested point value determiner 220 and change that value into the intermediary currency. In general, the intermediary currency is a system specific currency utilized by intermediary system 201 to provide a standardized value system for any points that are being exchanged.

In one embodiment, the intermediary currency would have an actual value, e.g., redemption of points would effectively result in a flat exchange based on the value of the exchange specific currency. In one embodiment, the intermediary currency is an investment mechanism into the overall rewards platform.

In one embodiment, after the exchange of point-to intermediary currency, the intermediary currency is exchanged at requested point exchanger 240 for an equivalent amount of the requested points. The exchanged points 250 are then provided to the entity.

In one embodiment, such as the peer-to-peer exchange, the value of the points exchanged by each entity can be based on the initial exchange. For example, in a peer-to-peer exchange between customer X and customer Y, customer X has points in program A 110 and would like to exchange some of her program A 110 points to obtain 500 points from Customer Y's program B 111. As such, the value of the program A110 points of customer X would be determined by point-to-currency exchanger 215. Similarly, the value of the 500 points of Customer Y's program B 111 would also be determined. Additionally, any fees or the like that would be deducted by optional point deductor 208 would also be determined. In one embodiment, any additional fees could be divided equally between the peers in the exchange or could be adjusted according to a negotiated percentage up to 100% of the additional fees could be taken from one of the parties in the peer-to-peer group.

In an equal fee sharing example, using intermediary 201, the determination of the value of the 500 points from program B111 is equivalent to 750 points from program A110. In addition, the point deductor 208 would deduct 6 program A110 points and 4 program B111 points to make the exchange. As such, customer X will provide 756 program A110 points while customer B will provide 504 program B111 points into intermediary 201. The exchange would then provide the 500 program B111 points to customer X and provide the 750 program A110 points to customer B.

In a single party fee example, using intermediary 201, the determination of the value of the 500 points from program B111 is equivalent to 750 points from program A110. In addition, the point deductor 208 would deduct 6 program A110 points for customer X's use of the exchange (and then an additional 6 program A points for customer Y's use of the exchange) to make the exchange. As such, customer X will provide 762 program A110 points while customer B will provide 500 program B111 points into intermediary 201. The exchange would then provide the 500 program B111 points to customer X and provide the 750 program A110 points to customer B. Although, two examples are shown, it should be appreciated that the fees could be split at percentages other than the equal split or 100% by one party.

In one embodiment, after the exchange of point-to intermediary currency, the value of the intermediary currency is added to an entity account 233 of database 230. It should be appreciated that database 230 can include a number of different entity accounts. By utilizing an entity account 233, the existing points 205 can be put into the exchange and some or all of the value can be exchanged from one or more different reward program points while the remaining value can be stored for later utilization.

Similarly, after the entity's intermediary currency is exchanged at requested point exchanger 240 for the number of requested points 206. There may be a left over amount of intermediary currency. That left over intermediary currency can then be put into entity account 233 from requested point exchanger 240. Moreover, if the intermediary currency was initially placed into entity account 233 by point-to-currency exchanger 215, requested point exchanger 240 would access entity account 233 and deduct the amount of intermediary currency necessary to obtain the requested points 206.

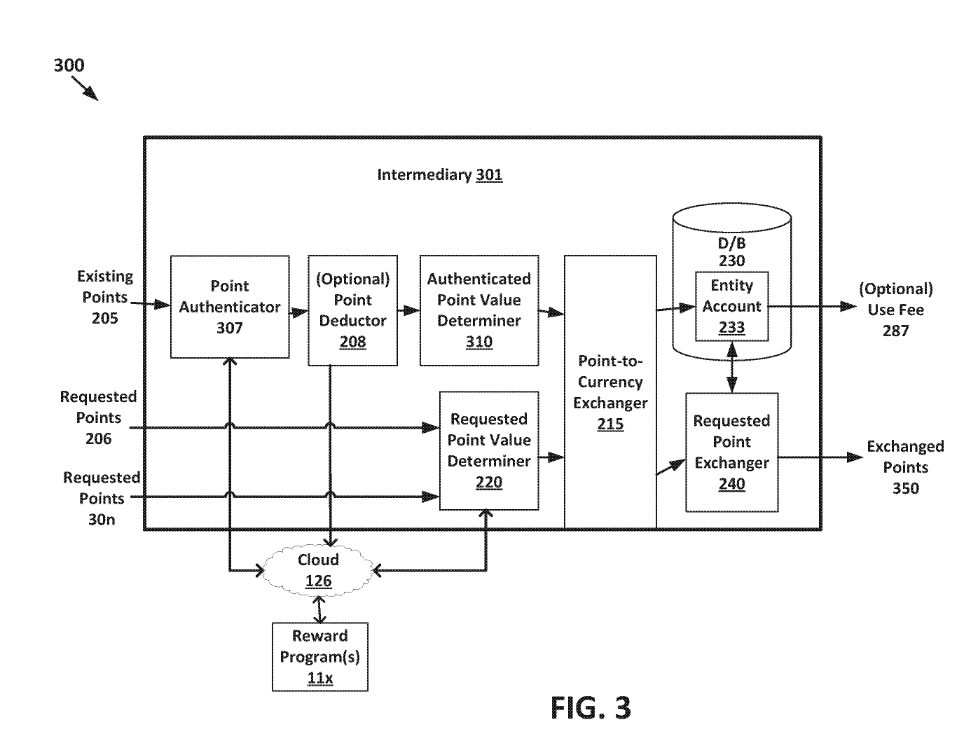

With reference now to FIG. 3, a block diagram 300 of further detailed version of an intermediary system 301 to manage a point exchange across a plurality of different reward program(s) 11x is shown in accordance with an embodiment. Although a number of distinct components are shown in block diagram 300, it should be appreciated that one or more of the components may be combined. Similarly, one or more of the components could be located separately from one another and communicate via cloud 126. For purposes of clarity, only those aspects of intermediary system 301 that are different from similar aspects of intermediary system 201 of FIG. 2 are discussed.

Intermediary system 301 includes a point authenticator 307, authenticated point value determiner 310, and at least one additional requested yet another type of reward program points.

Point authenticator 307 is utilized by intermediary system 301 to authenticate, validate, or otherwise ensure that the existing points 205 provided to intermediary system 301 are legitimate points that are properly possessed by the entity providing the existing points 205. Point authenticator 307 could authenticate the existing points 205 using a number of methods such as a hash of some or all of the data included with each existing point, by accessing the reward program(s) 11x, via cloud 126, to authenticate the existing points 205, the entity to which existing points 205 were issued, and the like.

In one embodiment, any unauthenticated existing points 205 would be removed from the existing points 205 by point authenticator 307. Further, point authenticator 307 could provide a flag for entity account 233 regarding the invalid points. Such a flag could result in the entity being placed under higher scrutiny, a partial or full ban on the entity utilizing the exchange, a review of other exchanges made by the entity, or the like. Once the existing points 205 are authenticated, they are passed through optional point deductor 208 to authenticated point value determiner 310.

Intermediary system 301 further allows at least one additional request for points to be made. For example, the entity may provide existing points 205 and request that x number of points be obtained for requested points 206 (e.g., a second reward points program) and y number of points be obtained for requested points 30n (e.g., a third reward points program). In general, the request may be for an equal amount of requested points 206 and requested points 30n, a specific amount of requested points 206 and a remaining value of requested points 30n, a specific amount of requested points 30n and a remaining value of requested points 206, or some combination thereof. Further, although two requested points are shown, there may be requests for points for more than two different reward programs. The use of requested points 206 and requested points 30n herein is provided for purposes of clarity. Exchanged points out 350 would include the requested points 206 and requested points 30n that were exchanged.

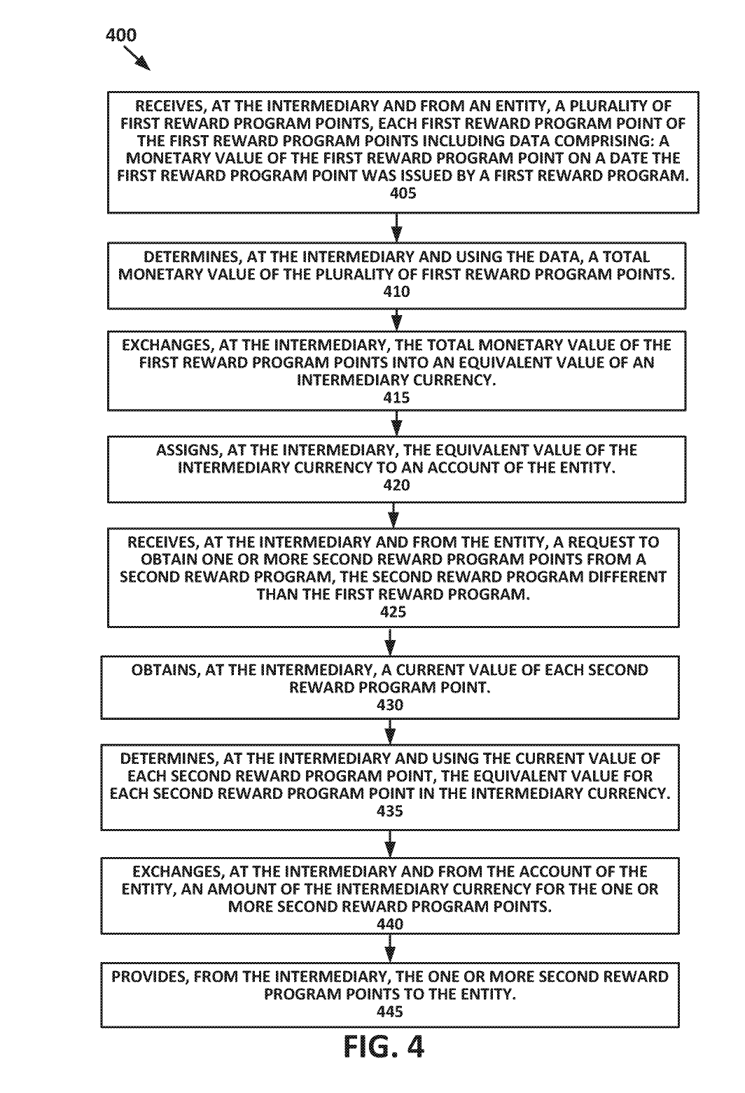

With reference now to FIG. 4, a flowchart 400 of a method for utilizing an intermediary to manage a point exchange across a plurality of different reward programs is shown in accordance with an embodiment.

With reference now to 405 of FIG. 4 and to FIGS. 2 and 3, one embodiment receives, at the intermediary and from an entity, a plurality of first reward program points, each first reward program point of the first reward program points including data comprising: a monetary value of the first reward program point on a date the first reward program point was issued by a first reward program. For example, existing points 205 received by intermediary system 201 or intermediary system 301.

One embodiment authenticates each first reward program point of the plurality of first reward program points (e.g., existing points 205) to determine a total number of authenticated first reward program points. For example, as discussed herein, point authenticator 307 would authenticate the existing points 205 using a number of methods such as a hash of some or all of the data included with each existing point, by accessing the reward program(s) 11x, via cloud 126, to authenticate the existing points 205, the entity to which existing points 205 were issued, and the like.

In one embodiment, any unauthenticated existing points 205 would be removed from the existing points 205 by point authenticator 307. Further, point authenticator 307 could provide a flag for entity account 233 regarding the invalid points. Such a flag could result in the entity being placed under higher scrutiny, a partial or full ban on the entity utilizing the exchange, a review of other exchanges made by the entity, or the like.

In one embodiment, an optional point deductor 208 deducts, at a time of the receiving of the plurality of first reward program points (or after the first reward program points have been authenticated), a predetermined number of first reward program points. For example, optional point deductor will deduct 5% of the existing points 205 from the total for each exchange. In one embodiment, the predetermined number of deducted first reward program points will be returned to a first retailer maintaining the first reward program 110. Moreover, the predetermined number of first reward program points will be identified as being redeemed. In one embodiment, optional point deductor 208 will utilize a network connection such as cloud 126 to access the first reward program 110 and inform the point program of the points redemption.

Referring now to 410 of FIG. 4 and to FIGS. 2 and 3, one embodiment determines, at the intermediary and using the data, a total monetary value of the plurality of first reward program points. For example, point value determiner 210 will access the point reward information for each point provided. Examples of data associated with each first reward program point includes data, such as but not limited to, a date the first reward program point was issued, a time the first reward program point was issued, a physical location of computing device 101 when the first reward program point was issued, a monetary value of the first reward program point on a date the first reward program point was issued by a first reward program, information identifying the first reward program, information identifying the entity that owns of the first reward program point, information identifying a date the first reward program point was obtained by the entity, and the like.

In so doing, point value determiner 210 will be able to determine the actual monetary value of each point of existing points 205. For example, if 30,000 points were initially received at intermediary system 201, it is likely that a number of the points would have been obtained at different times. As such, one or more of the points could have different values, or all of the points could have the same value.

For example, 30,000 points may have been received from a reward program having a defined point value of 1 round trip airline ticket worth no more than $400 dollars for every 30,000 points. Here, point value determiner 210 would determine that the total value of existing points 205 is $400.00 dollars

In another example, 10,000 points were initially received at a reward program value of $0.02 cents per reward point. Another 5,000 were received at a program value of $0.05 cents per reward point. The third 15,000 were received at a program value of $0.01 cent per reward point. As such, the point value determiner 210 would determine that the total value of existing points 205 is $600.00

In yet another example, 20,000 of the points could have been priced at 200 points for a free cup of coffee (a £3.00 value), while 10,000 of the points could have been valued at 500 points for a free sandwich (a £5.00 value). In this example, point value determiner 210 would determine that the total value of existing points 205 is £300.00.

At 415 of FIG. 4 and to FIGS. 2 and 3, one embodiment exchanges, at the intermediary, the total monetary value of the first reward program points into an equivalent value of an intermediary currency using point-to-currency exchanger 215. In general, the intermediary currency could be a currency or points based system. For example purposes in the following discussion, one point (or buck) of intermediary currency could be valued at $1.00.

Therefore, using the first example above (e.g., the existing points 205 having a value of $400.00 and the intermediary currency valued at $1.00 dollars), the exchange of existing points 205 (regardless of how many existing points 205 were provided) at point-to-currency exchanger 215 would result in 400 intermediary currency points, or in a currency based system, 400 intermediary currency bucks.

Using the third example above (e.g., the existing points 205 having a value of £300.00 and the intermediary currency valued at $1.00 dollars) the exchange of existing points 205 (e.g., £300.00) at point-to-currency exchanger 215 would further include the present exchange rate. For example, £1.00=$1.43 dollars. As such, the exchange of existing points 205 would result in 427.99 intermediary currency points, or intermediary currency bucks (e.g., 300*1.43).

With reference now to 420 of FIG. 4 and to FIGS. 2 and 3, one embodiment assigns, at the intermediary, the equivalent value of the intermediary currency to an account of the entity. That is, in one embodiment, after the exchange of point-to intermediary currency, the value of the intermediary currency is added to an entity account 233 of database 230. It should be appreciated that database 230 can include a number of different entity accounts. By utilizing an entity account 233, the existing points 205 can be put into the exchange and the value stored for later utilization.

In one embodiment, a predetermined amount of intermediary currency is deducted as a use fee 287. Use fee 287 could be a flat fee, a percentage of the equivalent value of the intermediary currency, a variable fee based on a number of times the entity has used the intermediary system 201, or a combination thereof. In one embodiment, use fee 287 could be provided to rewards program management companies to offset liability created by the additional rewards fulfillments, to retailers, to a provider or maintainer of intermediary system 201, another party, or a combination of two or more of the different parties.

Referring now to 425 of FIG. 4 and to FIG. 2, one embodiment receives, at the intermediary and from the entity, a request to obtain one or more second reward program points (e.g., requested points 206) from a second reward program 111. In general, the first reward program 110 is maintained by a first retailer while the second reward program 111 is maintained by a second retailer. The first retailer being a distinctly different corporation that is not related to the second retailer.

In one embodiment, the request for the requested points 206 does not include an amount of requested points 206, instead, the request is to exchange as much of the intermediary currency as available, from the entity account 233, to obtain as many second reward program points (e.g., exchanged points 350) as possible. In another embodiment, the request for the requested points 206 includes an amount of requested points 206 to be obtained.

At 430 of FIG. 4 and referring to FIG. 2, one embodiment obtains, at the intermediary, a current value of each second reward program point. For example, requested point value determiner 220 determines the present value for each point of the requested points 206. In one embodiment, requested point value determiner 220 utilizes a network connection such as cloud 126 to access the reward program(s) 11x and obtain the present value of the requested points 206. For example, point value determiner 220 determines that each requested point of requested points 206 is valued at 0.35 euros.

With reference now to 435 of FIG. 4 and to FIG. 2, one embodiment determines, at the intermediary and using the current value of each second reward program point, the equivalent value for each second reward program point in the intermediary currency. That is, point-to-currency exchanger 215 will determine the value of each (or a group of) requested points 206 in the intermediary currency. Thus, using the above example, if each requested point is valued at 0.35 euros, point-to-currency exchanger 215 will utilize the present conversion rate (1 Euro=1.25 dollars) to determine that each requested point is valued at 0.44 intermediary currency points, or intermediary currency bucks (e.g., 0.35*1.25).

At 440 of FIG. 4 and referring to FIG. 2, one embodiment exchanges, at the intermediary system 201 and from the entity account 233, an amount of the intermediary currency for the one or more second reward program points e.g., requested points 206. Thus, using the above examples, if the entity wanted to obtain 100 requested points 206, requested point exchanger 240 would withdraw 440 intermediary currency points, or intermediary currency bucks (e.g., 100*0.44) from entity account 233.

In one embodiment, after the entity's intermediary currency is exchanged at requested point exchanger 240 for the number of requested points 206. There may be a left over amount of intermediary currency that would remain in entity account 233. In another embodiment, all of the existing points 205 are exchanged for an equivalent value of requested points 206 and nothing will remain in entity account 233.

Referring now to 445 of FIG. 4 and to FIG. 2, one embodiment provides, from the intermediary, the one or more second reward program points to the entity. Using the above example, the 100 exchanged points 250 would be provided to the entity.

Referring again to 425 of FIG. 4 and now to FIG. 3, one embodiment receives, at the intermediary and from the entity, a request to obtain one or more second reward program points (e.g., requested points 206) from a second reward program 111 and one or more third reward program points (e.g., requested points 30n), the third reward program 112 different from both the second reward program 111 and the first reward program 110. In one embodiment, the request for requested points 30n does not include an amount of requested points 30n, instead, the request is to exchange as much of the intermediary currency that remains, from the entity account 233, to obtain as many third reward program points as possible. In another embodiment, the request for requested points 30n includes an amount of requested points 30n to be obtained.

Referring again to 430 of FIG. 4 and now to FIG. 3, one embodiment obtains, at the intermediary, a current value of each third reward program point. For example, requested point value determiner 220 determines the present value for each point of the requested points 206 and requested points 30n. In one embodiment, requested point value determiner 220 utilizes a network connection such as cloud 126 to access the reward program(s) 11x(e.g., programs 111 and 112 of FIG. 1) to obtain the present value of the requested points 206 and requested points 30n. For example, point value determiner 220 determines that each requested point of requested points 30n is valued at $0.05 cents.

Similarly, with reference again to 435 of FIG. 4 and now to FIG. 3, one embodiment determines, at the intermediary and using the current value of each third reward program point, the equivalent value for each third reward program point in the intermediary currency. That is, point-to-currency exchanger 215 will determine the value of each (or a group of) requested points 30n in the intermediary currency. Thus, using the above example, if each requested points 30n is valued at $0.05 cents, point-to-currency exchanger 215 will determine that each requested point is valued at 0.05 intermediary currency points, or intermediary currency bucks.

Once again at 440 of FIG. 4 and now to FIG. 3, one embodiment exchanges, at the intermediary system 301 and from the entity account 233, an amount of the intermediary currency for the one or more second reward program points (e.g., requested points 206) and the one or more third reward program points (e.g., requested points 30n). Thus, using the above examples, if the entity wanted to obtain 100 requested points 206 and 10,000 requested points 30n, requested point exchanger 240 would withdraw 940 intermediary currency points, or intermediary currency bucks from entity account 233. E.g., 440 intermediary currency points/bucks (e.g., 100*0.44) to cover the exchange of requested points 206 as well as 500 intermediary currency points/bucks (e.g., 10,000*0.05) to cover the exchange of requested points 30n.

In one embodiment, after the entity's intermediary currency is exchanged at requested point exchanger 240 for the number of requested points 206 and requested points 30n. There may be a left over amount of intermediary currency that would remain in entity account 233. In another embodiment, all of the existing points 205 are exchanged for an equivalent value of requested points 206 and requested points 30n and nothing will remain in entity account 233.

Referring again to 445 of FIG. 4 and now to FIG. 3, one embodiment provides, from the intermediary, the one or more second reward program points and third reward program points to the entity. Using the above example, the 100 second program points and the 500 third program points would be provided to the entity via exchanged points 350.

With reference now to FIG. 5, portions of the technology for providing a communication composed of computer-readable and computer-executable instructions that reside, for example, in a non-transitory computer-readable medium, a non-transitory computer-readable storage medium, or in non-transitory computer-readable storage media of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled to bus 504 for storing information and instructions for processors 506A, 506B, and 506C.

System 500 also includes computer usable non-volatile memory 510, e.g., read only memory (ROM), coupled to bus 504 for storing static information and instructions for processors 506A, 506B, and 506C. Also present in system 500 is a data storage unit 512 (e.g., a magnetic disk drive, optical disk drive, solid state drive (SSD), and the like) coupled to bus 504 for storing information and instructions. Computer system 500 also includes an optional alpha-numeric input device 514 including alphanumeric and function keys coupled to bus 504 for communicating information and command selections to processor 506A or processors 506A, 506B, and 506C. Computer system 500 also includes an optional cursor control device 516 coupled to bus 504 for communicating user input information and command selections to processor 506A or processors 506A, 506B, and 506C. Optional cursor control device may be a touch sensor, gesture recognition device, and the like. Computer system 500 of the present embodiment also includes an optional display device 518 coupled to bus 504 for displaying information.

Referring still to FIG. 5, optional display device 518 of FIG. 5 may be a liquid crystal device, cathode ray tube, OLED, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. Computer system 500 also includes an I/O device 520 for coupling system 500 with external entities. For example, in one embodiment, I/O device 520 is a modem for enabling wired or wireless communications between system 500 and an external network such as, but not limited to, the Internet or intranet. A more detailed discussion of the present technology is found below.

Referring still to FIG. 5, various other components are depicted for system 500. Specifically, when present, an operating system 522, applications 524, modules 526, and data 528 are shown as typically residing in one or some combination of computer usable volatile memory 508, e.g. random access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512. The present technology may be applied to one or more elements of described system 500.

System 500 also includes one or more signal generating and receiving device(s) 530 coupled with bus 504 for enabling system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one or more communication interface(s) 532 for coupling information to and/or from system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

The computing system 500 is only one example of a suitable computing environment and is not intended to suggest any limitation as to the scope of use or functionality of the present technology. Neither should the computing environment be interpreted as having any dependency or requirement relating to any one or combination of components illustrated in the example computing system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A non-transitory computer-readable storage medium having instructions embodied therein that when executed causes a computer system to perform a method for utilizing an intermediary to manage a point exchange across a plurality of different reward programs, the method comprising:
receiving, at the intermediary and from an entity, a plurality of first reward program points,
each first reward program point of the first reward program points including data comprising:
a monetary value of the first reward program point on a date the first reward program point was issued by a first reward program;
determining, at the intermediary and using the data, a total monetary value of the plurality of first reward program points;
exchanging, at the intermediary, the total monetary value of the first reward program points into an equivalent value of an intermediary currency;
assigning, at the intermediary, the equivalent value of the intermediary currency to an account of said entity;
receiving, at the intermediary and from the entity, a request to obtain one or more second reward program points from a second reward program,
the second reward program different than said first reward program;
obtaining, at the intermediary, a current value of each second reward program point;
determining, at the intermediary and using the current value of each second reward program point, the equivalent value for each second reward program point in the intermediary currency;
exchanging, at the intermediary and from the account of the entity, an amount of the intermediary currency for the one or more second reward program points; and
providing, from the intermediary, the one or more second reward program points to the entity.

2. The non-transitory computer-readable storage medium of claim 1, further comprising:
exchanging, from the account of the entity, as much of the intermediary currency available to obtain as many second reward program points as possible.

3. The non-transitory computer-readable storage medium of claim 1, further comprising:
receiving a request from the entity to obtain one or more third reward program points from a third reward program;
obtaining a current value of each third reward program point;
determining, using the current value of each third reward program point, the equivalent value for each third reward program point in the intermediary currency;
exchanging, from the account of the entity, at least a portion of the intermediary currency to obtain the one or more third reward program points; and
providing the one or more third reward program points to the entity.

4. The non-transitory computer-readable storage medium of claim 3, further comprising:
exchanging, from the account of the entity, a remainder of the intermediary currency to obtain as many of the third reward program points as possible.

5. The non-transitory computer-readable storage medium of claim 1, wherein the data further comprises:
information identifying the first reward program;
information identifying the entity that owns of the first reward program point; and
information identifying a date the first reward program point was obtained by the entity.

6. The non-transitory computer-readable storage medium of claim 1, further comprising:
deducting, at a time of the receiving of the plurality of first reward program points, a predetermined number of first reward program points,
the predetermined number of first reward program points being returned to a first retailer maintaining the first reward program,
the predetermined number of first reward program points identified as being redeemed.

7. The non-transitory computer-readable storage medium of claim 1, further comprising:
deducting from the equivalent value of the intermediary currency, a predetermined amount of intermediary currency,
the deducting of the predetermined amount of intermediary currency being a use fee,
the predetermined amount of intermediary currency selected from the group consisting of: a flat fee, a percentage of the equivalent value of the intermediary currency, and a variable fee based on a number of times the entity has used the intermediary.

8. The non-transitory computer-readable storage medium of claim 1, further comprising:
utilizing a point life expectancy feature to assign a date at which a value of the equivalent value of the intermediary currency or a value of the second reward program point will change, the change selected from the group consisting of: a loss of all value, a disappearance from the intermediary, a disappearance of the second reward program point, and a reduction in value over time.

9. A non-transitory computer-readable medium storing instructions, the instructions comprising:
one or more instructions that, when executed by one or more processors, cause the one or more processors to:
receive a plurality of first reward program points,
each first reward program point of the plurality of first reward program points including a plurality of metrics comprising:
information identifying a first reward program that issued the first reward program point,
information identifying an entity that owns of the first reward program point,
information identifying a date the first reward program point was obtained by the entity, and
information identifying a monetary value of the first reward program point on the date the first reward program point was obtained by the entity;
authenticate each first reward program point of the plurality of first reward program points to determine a total number of authenticated first reward program points;
determine, using the plurality of metrics, a total monetary value of the total number of authenticated first reward program points;
exchange the total monetary value of the total number of authenticated first reward program points into an equivalent value of an exchange specific currency;
assign the equivalent value of the exchange specific currency to an account of the entity;
receive, from the entity, a request to obtain one or more second reward program points from a second reward program;
obtain a current value of each second reward program point;
determine, using the current value of each second reward program point, the equivalent value for each second reward program point in the exchange specific currency;
exchange, from the account of the entity, an amount of the exchange specific currency for the one or more second reward program points; and
provide, the one or more second reward program points to the entity.

10. The non-transitory computer-readable medium of claim 9, where the one or more instructions, when executed by the one or more processors, further cause the one or more processors to:
exchange, from the account of the entity, as much of the exchange specific currency as available to obtain as many second reward program points as possible.

11. The non-transitory computer-readable medium of claim 9, further comprising:
receive a request from the entity to obtain one or more third reward program points from a third reward program;
obtain a current value of each third reward program point;
determine, using the current value of each third reward program point, the equivalent value for each third reward program point in the exchange specific currency;
exchange, from the account of the entity, at least a portion of the exchange specific currency to obtain the one or more third reward program points; and
provide the one or more third reward program points to the entity.

12. The non-transitory computer-readable medium of claim 9, where the one or more instructions, when executed by the one or more processors, further cause the one or more processors to:
deduct, after the plurality of first reward program points are authenticated, a predetermined number of authenticated first reward program points,
the predetermined number of authenticated first reward program points being returned to a first retailer maintaining the first reward program,
the predetermined number of authenticated first reward program points identified as being redeemed.

13. The non-transitory computer-readable medium of claim 9, where the one or more instructions, when executed by the one or more processors, further cause the one or more processors to:
deduct, from the equivalent value of the exchange specific currency, a predetermined amount of exchange specific currency,
the predetermined amount of exchange specific currency being a use fee,
the predetermined amount of exchange specific currency selected from the group consisting of: a flat fee, a percentage of the equivalent value of the exchange specific currency, and a variable fee based on a number of exchanges requested by the entity.

14. The non-transitory computer-readable medium of claim 9, wherein
the first reward program is maintained by a first retailer,
the second reward program is maintained by a second retailer, and
the first retailer is a distinctly different corporation than the second retailer.

15. A system comprising:
one or more computing devices to:
receive, at a central exchange and from an entity, a plurality of first reward program points,
the first reward program points related to a first reward program,
each first reward program point of the first reward program points including a plurality of metrics comprising:
information identifying the first reward program,
information identifying the entity that owns of the first reward program point,
information identifying a date the first reward program point was obtained by the entity, and
information identifying a monetary value of the first reward program point on the date the first reward program point was obtained by the entity;
validated, at the central exchange and using the plurality of metrics, each first reward program point of the plurality of first reward program points to determine a total number of validated first reward program points;
determine, at the central exchange and using the plurality of metrics, a total monetary value of the total number of validated first reward program points;
exchange, at the central exchange, the total monetary value of the total number of validated first reward program points into an equivalent value of a central exchange currency,
the central exchange currency having a defined value only within the central exchange;
assign, at the central exchange, the equivalent value of the central exchange currency to an account of said entity;
receive, at the central exchange and from the entity, a request to obtain one or more second reward program points from a second reward program;
obtain, at the central exchange, a current value of each second reward program point;
determine, at the central exchange and using the current value of each second reward program point, the equivalent value for each second reward program point in the central exchange currency;
exchange, at the central exchange and from the account of the entity, an amount of the central exchange currency for the one or more second reward program points; and
provide, from the central exchange, the one or more second reward program points to the entity.

16. The system of claim 15, further comprising:
one or more devices to:
exchange, from the account of the entity, as much of the exchange specific currency as available to obtain as many second reward program points as possible.

17. The system of claim 15, further comprising:
one or more devices to:
receive a request from the entity to obtain one or more third reward program points from a third reward program;
obtain a current value of each third reward program point;
determine, using the current value of each third reward program point, the equivalent value for each third reward program point in the exchange specific currency;
exchange, from the account of the entity, at least a portion of the exchange specific currency to obtain the one or more third reward program points; and
provide the one or more third reward program points to the entity.

18. The system of claim 17, further comprising:
one or more devices to:
exchange, from the account of the entity, a remainder of the intermediary currency to obtain as many of the third reward program points as possible.

19. The system of claim 15, further comprising:
one or more devices to:
deduct, after the plurality of first reward program points are authenticated, a predetermined number of authenticated first reward program points,
the predetermined number of authenticated first reward program points being returned to a first retailer maintaining the first reward program,
the predetermined number of authenticated first reward program points identified as being redeemed.

20. The system of claim 15, further comprising:
one or more devices to:
deduct, from the equivalent value of the exchange specific currency, a predetermined amount of exchange specific currency,
the predetermined amount of exchange specific currency being a use fee,
the predetermined amount of exchange specific currency selected from the group consisting of: a flat fee, a percentage of the equivalent value of the exchange specific currency, and a variable fee based on a number of exchanges requested by the entity.
